(19) United States
(12) Patent Application Publication
(10) Pub. No.: US 2011/0181064 A1
(43) Pub. Date: Jul. 28, 2011

(54) PET MESS TOOL

(76) Inventor: James L. Moore, Taylor, MI (US)

(21) Appl. No.: 13/027,483

(22) Filed: Feb. 15, 2011

Related U.S. Application Data
(63) Continuation-in-part of application No. 12/646,159, filed on Dec. 23, 2009.
(60) Provisional application No. 61/304,628, filed on Feb. 15, 2010.

(51) Int. Cl. A01K 29/00

(52) U.S. Cl. 294/1.4; 294/1.3

(57) ABSTRACT

A tool for cleaning a pet mess from a surface includes a tube shaped body having wall defining a passage therethrough, a handle extending generally rearwardly from the body, and an opening formed in the body exposing a rear edge of a bottom portion of the wall, whereby when the bottom portion of the wall is placed on the surface with the rear edge adjacent the pet mess, the handle is grasped by a human hand for pulling the body toward the pet mess and between the mess and the surface to scoop the mess into the passage.

### CROSS-REFERENCE TO RELATED APPLICATION

This application is a continuation-in-part of the co-pending U.S. patent application Ser. No. 12/646,159 filed Dec. 23, 2009.

This application claims the benefit of U.S. Provisional Patent Application Ser. No. 61/304,628 filed Feb. 15, 2010.

### FIELD OF THE INVENTION

The present invention relates to a tool for removing pet “messes” from surfaces such as floors, rugs, and furniture.

### BACKGROUND OF THE INVENTION

Domestic pets, such as cats and dogs, are prone to depositing “messes” such as feces and vomit on surfaces inside and outside the home. These “messes” can be difficult to clean up. When a scoop type tool is used, the “mess” tends to be pushed ahead rather than moving rearwardly into the tool. Therefore, it would be desirable to develop a tool for removing pet “messes” from surfaces that would enable the “mess” to be picked up in place.

### SUMMARY OF THE INVENTION

Concordant and consistent with the present invention, a tool for removing pet “messes” from surfaces that would enable the “mess” to be picked up in place, has surprisingly been discovered.

In one embodiment, a tool for cleaning a pet “mess” from a surface comprises: a tube shaped body having wall defining a passage therethrough; a handle extending generally rearwardly from the body; and an opening formed in the body exposing a rear edge of a bottom portion of the wall, whereby when the bottom portion of the wall is placed on the surface with the rear edge adjacent the pet “mess”, the handle is grasped by a human hand for pulling the body toward the pet “mess” and between the “mess” and the surface to scoop the “mess” into the passage.

In another embodiment, a tool for cleaning a pet “mess” from a surface comprises: a body having a wall defining a passage therethrough; a handle coupled to the body and extending generally rearwardly therefrom; a pair of spaced apart openings are formed in the body to provide access to the passage, wherein a rear edge of a bottom portion of the wall is exposed by one of said openings, whereby when the bottom portion of the wall is placed on the surface with the rear edge adjacent the pet “mess”, the handle is grasped by a human hand for pulling the body toward the pet “mess” and between the “mess” and the surface to scoop the “mess” into the passage; and a bag having and open end and a closed end, the open end disposed around a periphery of the wall to enclose the passage.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a front perspective view of a pet mess tool according to an embodiment of the present invention;

FIG. 2 is a rear perspective view of the pet mess tool of FIG. 1;

FIG. 3 is a fragmentary side elevation view in partial cross section of the pet mess tool of FIG. 1;

FIG. 4 is a front perspective view of a pet mess tool according to another embodiment of the present invention;

FIG. 5 is a rear perspective view of the pet mess tool of FIG. 4;

FIG. 6 is a fragmentary side elevation view in partial cross section of the pet mess tool of FIG. 4;

FIG. 7 is a front perspective view of a pet mess tool according to another embodiment of the present invention;

FIG. 8 is a rear perspective view of the pet mess tool of FIG. 7;

FIG. 9A is a fragmentary side elevation view in partial cross section of the pet mess tool of FIG. 7;

FIG. 9B is a fragmentary side elevation view in partial cross section of the pet mess tool of FIG. 7;

FIGS. 10-15 are perspective views of a pet mess tool according to another embodiment of the present invention;

FIGS. 16-20 are perspective views of the pet mess tool of FIGS. 10-15, showing a bag in a first configuration; and

FIGS. 21-22 are perspective views of the pet mess tool of FIGS. 10-15, showing a bag in a second configuration.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

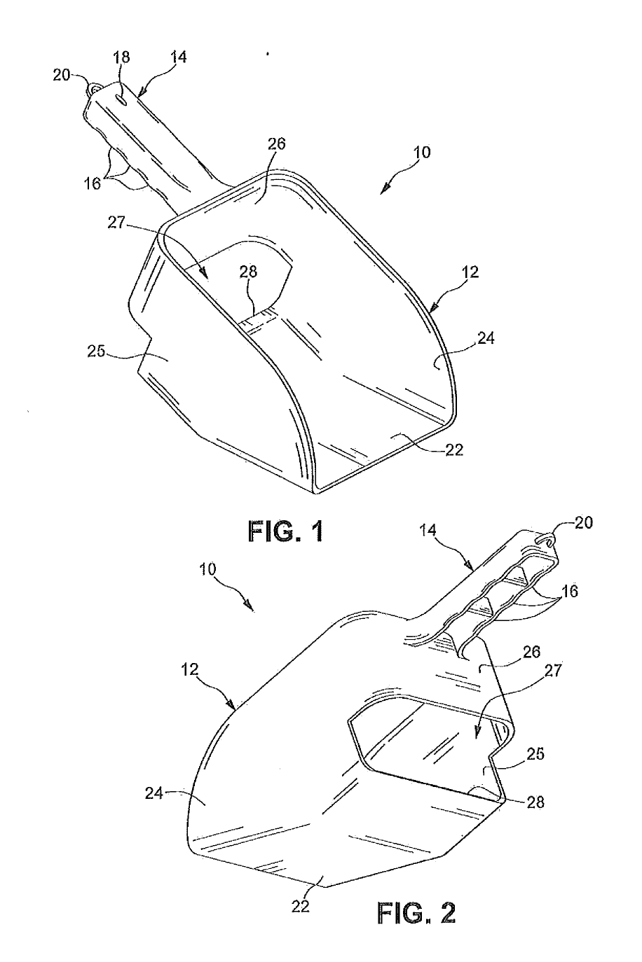

FIGS. 1-3 illustrate a pet mess tool 10 according to an embodiment of the present invention. As shown, the tool 10 has a cup shaped body 12 from which extends a handle 14. As a non-limiting example, the handle 14 includes a plurality of ridges 16 formed therein to provide an ergonomic gripping surface for a human hand. As a further non-limiting example, a means for suspending the tool 10 during storage thereof is formed in the handle 14 such as an aperture 18 or a hanging tab 20.

The body 12 has a bottom wall 22 coupled to a pair of spaced apart side walls 24, 25. A rear wall 26 extends between the side walls 24, 25 and connects the bottom wall 22 to close the rear of the body 12. The bottom wall 22 extends in a generally horizontal plane forward from the rear wall 26 along a portion of the body 12 and then angles upwardly to an open front end of the body 12.

An opening 27 is formed in a lower portion of the rear wall 26 down to the plane of the bottom wall 22. The opening 27 exposes a rear edge 28 of the bottom wall 22.

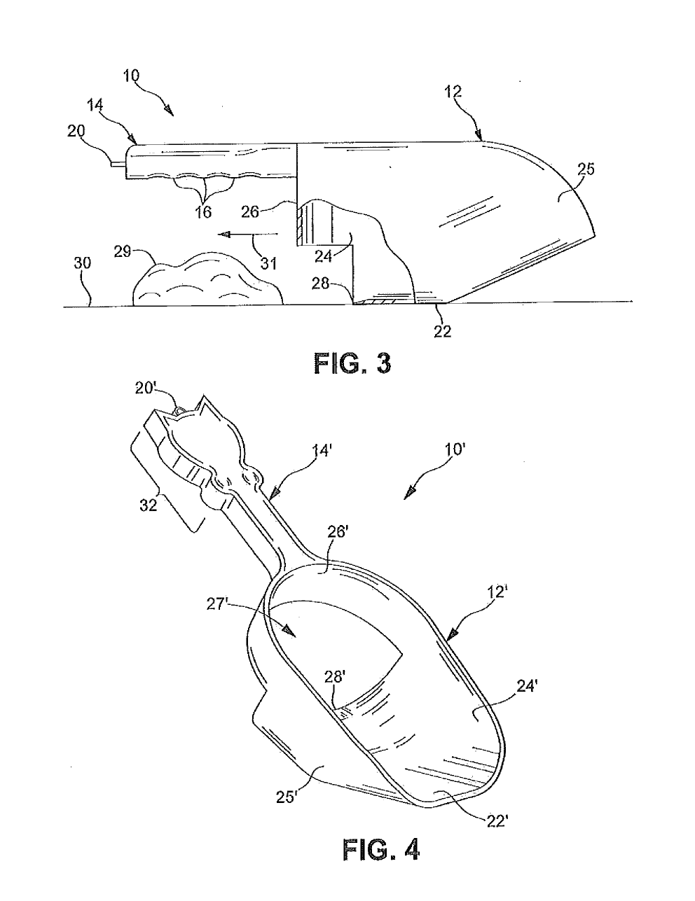

As more clearly shown in FIG. 3, a pet “mess” 29 is resting on a surface 30 such as a floor, a rug, a furniture seat cushion, etc. The tool 10 is positioned with the bottom wall 22 resting on the surface 30 and the rear edge 28 adjacent the “mess” 29. Using the handle 12, the tool 10 is rapidly pulled in the direction of an arrow 31 to engage the “mess” 29. Since a body at rest tends to stay at rest, the “mess” 29 tends to stay in place as the edge 28 is pulled between the “mess” 29 and the surface 30 in the direction of the arrow 31 to scoop the “mess” 29 into the body 12. As shown, a portion of the bottom wall 22 is tapered toward the rear edge 28 to assist in separating the “mess” 29 from the surface 30. However, it is understood that the rear edge 28 may have any shape, as desired.

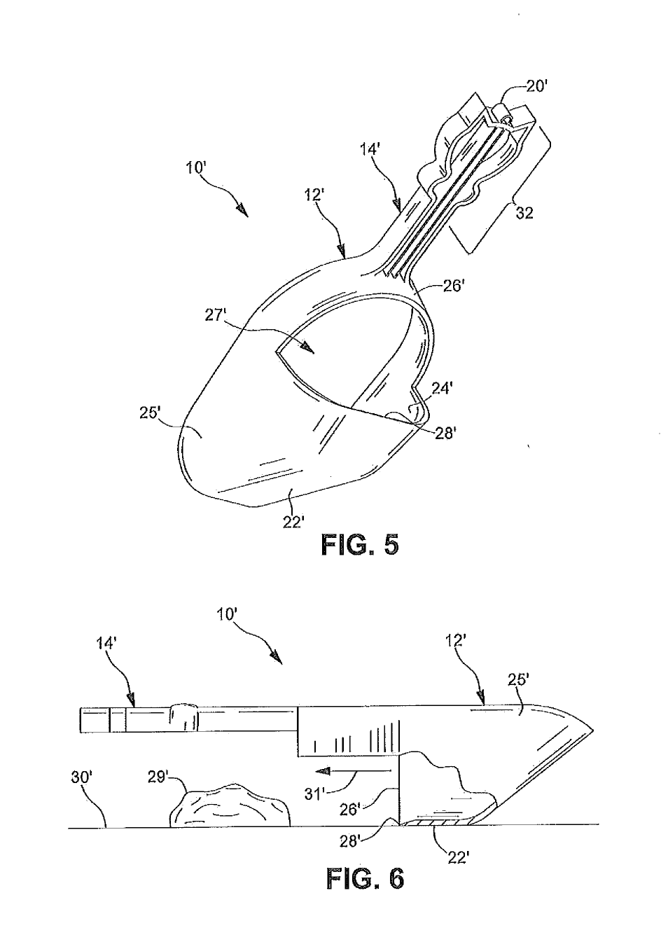

FIGS. 4-6 illustrate a pet mess tool 10′ according to another embodiment of the present invention similar to the pet mess tool 10 of FIGS. 1-3, except as described below. Structure repeated from the description of FIGS. 1 and 2 includes the same reference numeral and a prime (′) symbol.

As shown, the tool 10′ is smaller in size relative to the tool 10. The tool 10′ has a cup shaped body 12′ from which extends a handle 14′. As a non-limiting example, the handle 14′ includes an ornamental feature 32 formed such as a silhouette of a pet. It is understood that the ornamental feature 32 can be designed to provide an ergonomic gripping surface for a human hand. As a further non-limiting example, a means for suspending the tool 10′ during storage thereof is formed in the handle 14′ such as a hanging tab 20′.

As more clearly shown in FIG. 6, a pet “mess” 29′ is resting on a surface 30′ such as a floor, a rug, a furniture seat cushion, etc. The tool 10′ is positioned with the bottom wall 22′ resting on the surface 30′ and the rear edge 28′ adjacent the “mess” 29′. Using the handle 12′, the tool 10′ is rapidly pulled in the direction of an arrow 31′ to engage the “mess” 29′. Since a body at rest tends to stay at rest, the “mess” 29′ tends to stay in place as the edge 28′ is pulled between the “mess” 29′ and the surface 30′ in the direction of the arrow 31′ to scoop the “mess” 29′ into the body 12′. As shown, the rear edge 28′ can be tapered to assist in separating the “mess” 29′ from the surface 30′. However, it is understood that the rear edge 28′ may have any shape, as desired.

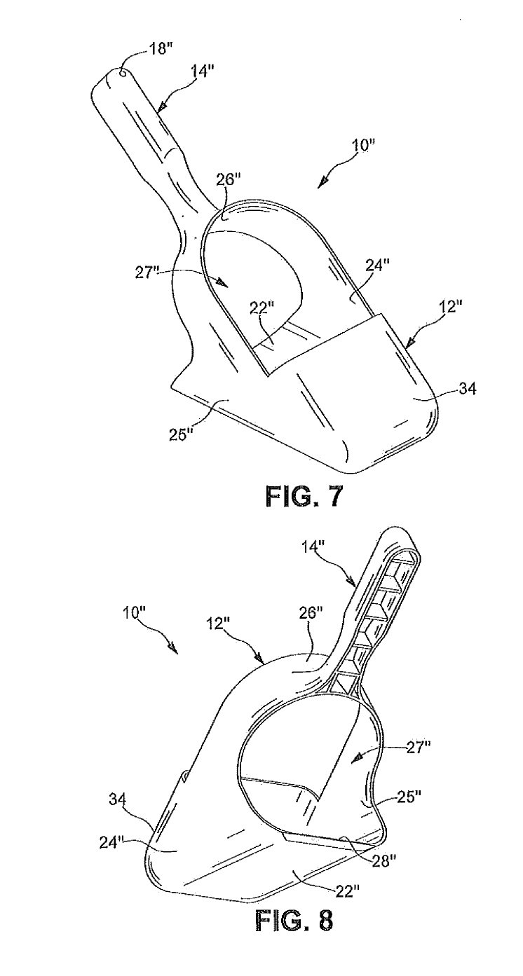

FIGS. 7-9 illustrate a pet mess tool 10″ according to another embodiment of the present invention similar to the pet mess tool 10 of FIGS. 1-3, except as described below. Structure repeated from the description of FIGS. 1-3 includes the same reference numeral and a double-prime (″) symbol.

As shown, the tool 10″ has a cup shaped body 12″ from which extends a handle 14″. As a non-limiting example, an aperture 18″ is formed in the handle 14″ for suspending the tool 10″ during storage thereof.

The body 12″ has a bottom wall 22″ coupled to a pair of spaced apart side walls 24″, 25″. A rear wall 26″ extends between the side walls 24″, 25″ and connects the bottom wall 22″ to close the rear of the body 12″. The bottom wall 22″ extends in a generally horizontal plane forward from the rear wall 26″. A front wall 34 extends between the side walls 24″, 25″ and connects the bottom wall 22″ to close at least a portion of the front of the body 12″.

An opening 27″ is formed in a lower portion of the rear wall 26″ down to the plane of the bottom wall 22″. A rear edge 28″ of the bottom wall 22″ is disposed adjacent the opening 27″.

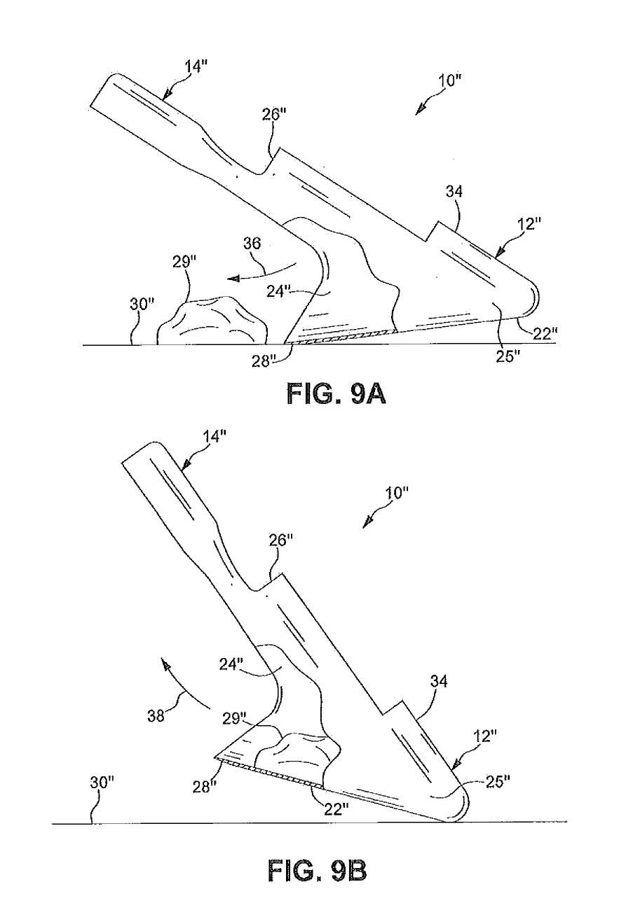

As more clearly shown in FIGS. 9A-9B, a pet “mess” 29″ is resting on a surface 30″ such as a floor, a rug, a furniture seat cushion, etc. The tool 10″ is positioned with a portion of the bottom wall 22″ resting on the surface 30″ and adjacent the “mess” 29″. Using the handle 14″, the tool 10″ is rapidly pulled in the direction of an arrow 36 to engage the “mess” 29″. Since a body at rest tends to stay at rest, the “mess” 29″ tends to stay in place as the edge 28″ is pulled between the “mess” 29″ and the surface 30″ in the direction of the arrow 36 to scoop the “mess” 29″ into the body 12″. Once the “mess” 29″ is in the body 12″ a continued scooping motion in the direction of arrow 38 causes the “mess” 29″ to move toward the front wall 34 and rest thereagainst for transfer and subsequent disposal. As shown, the rear edge 28″ can be tapered to assist in separating the “mess” 29″ from the surface 30″. However, it is understood that the rear edge 28″ may have any shape, as desired.

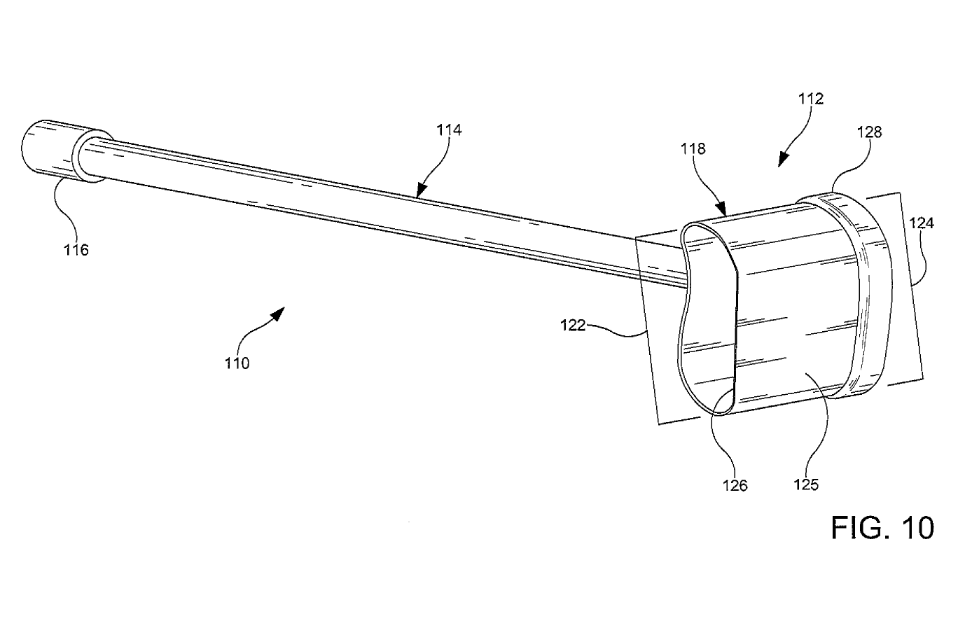

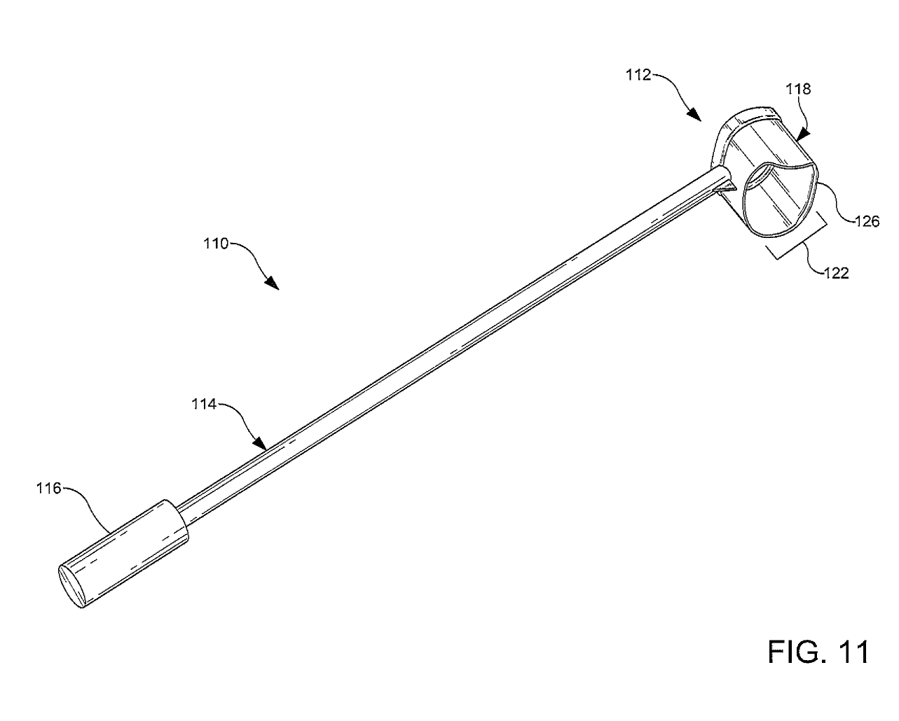

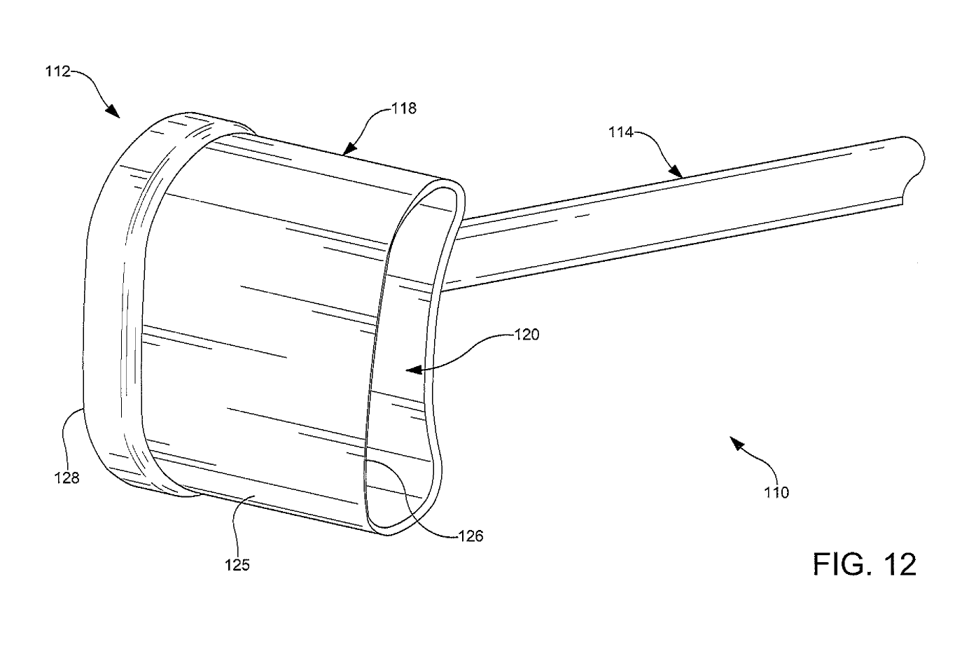

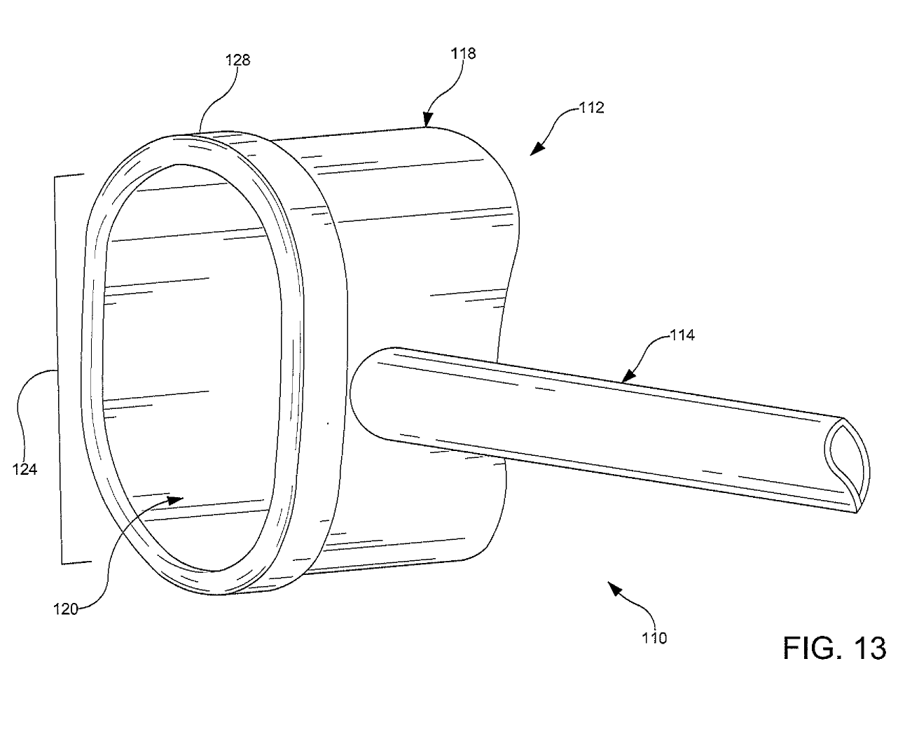

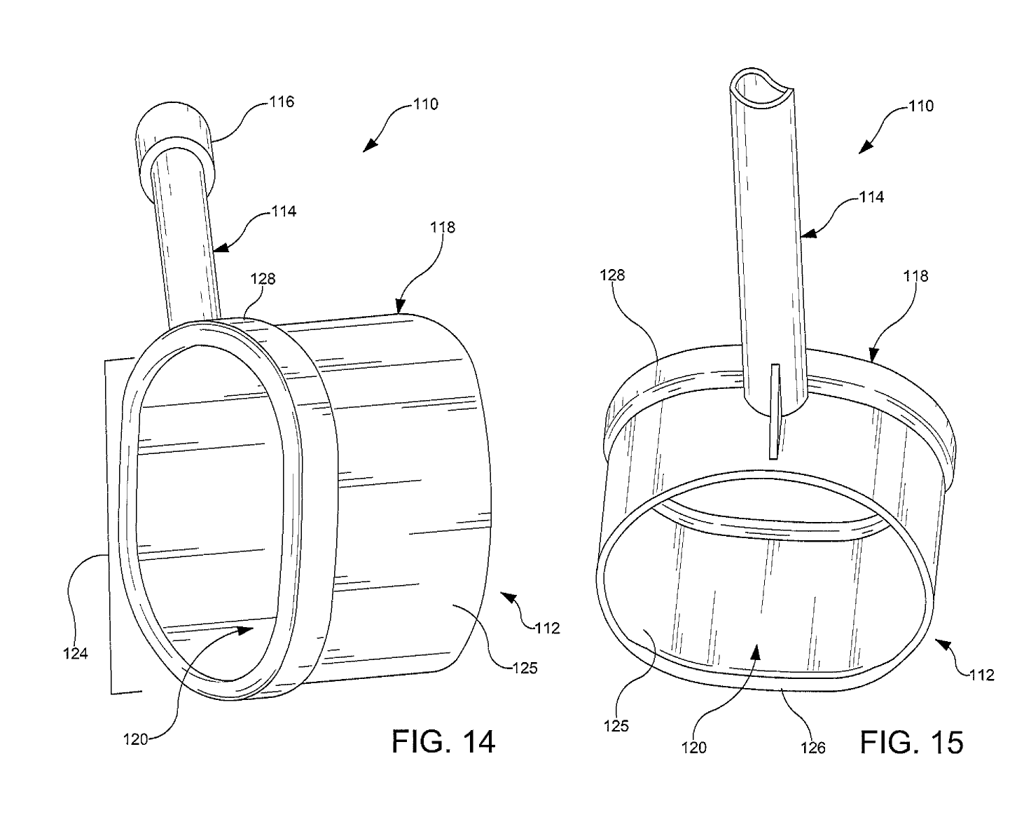

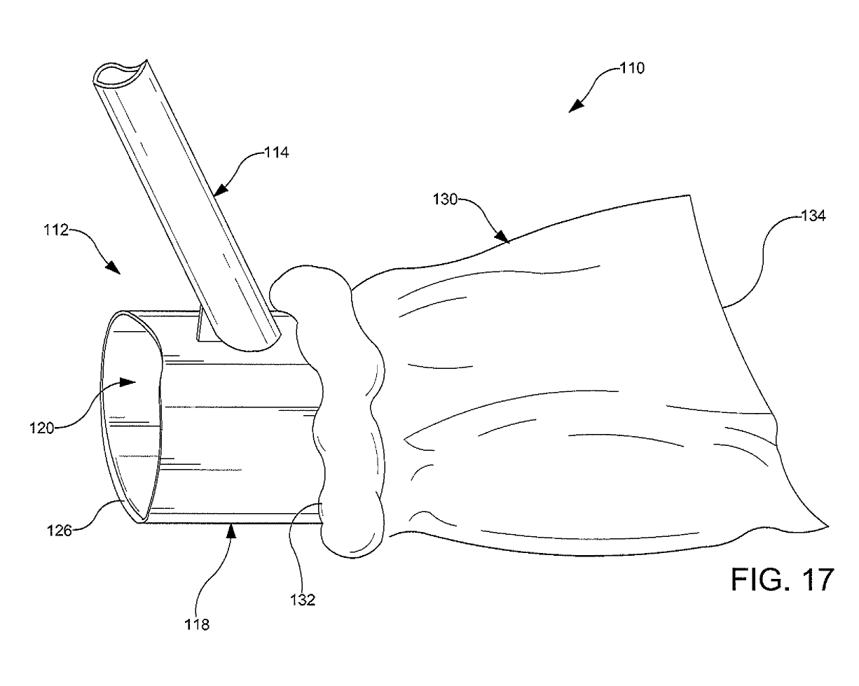

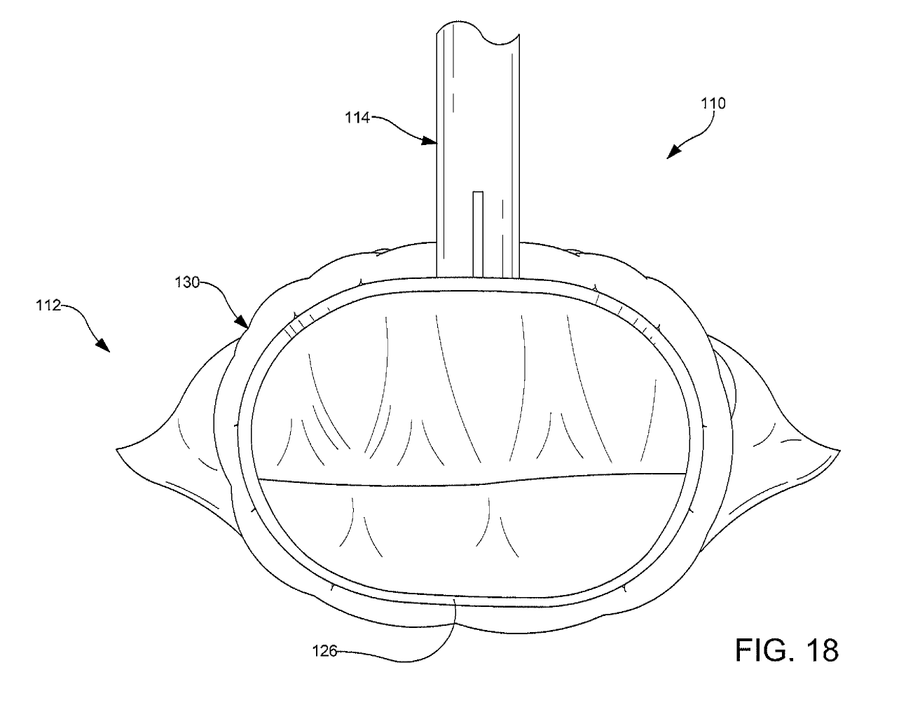

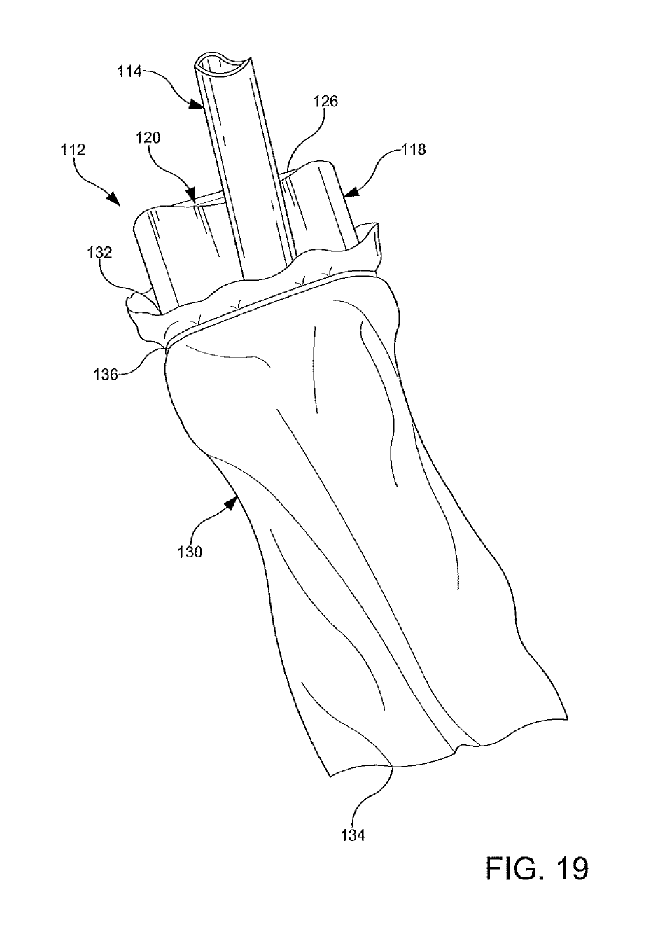

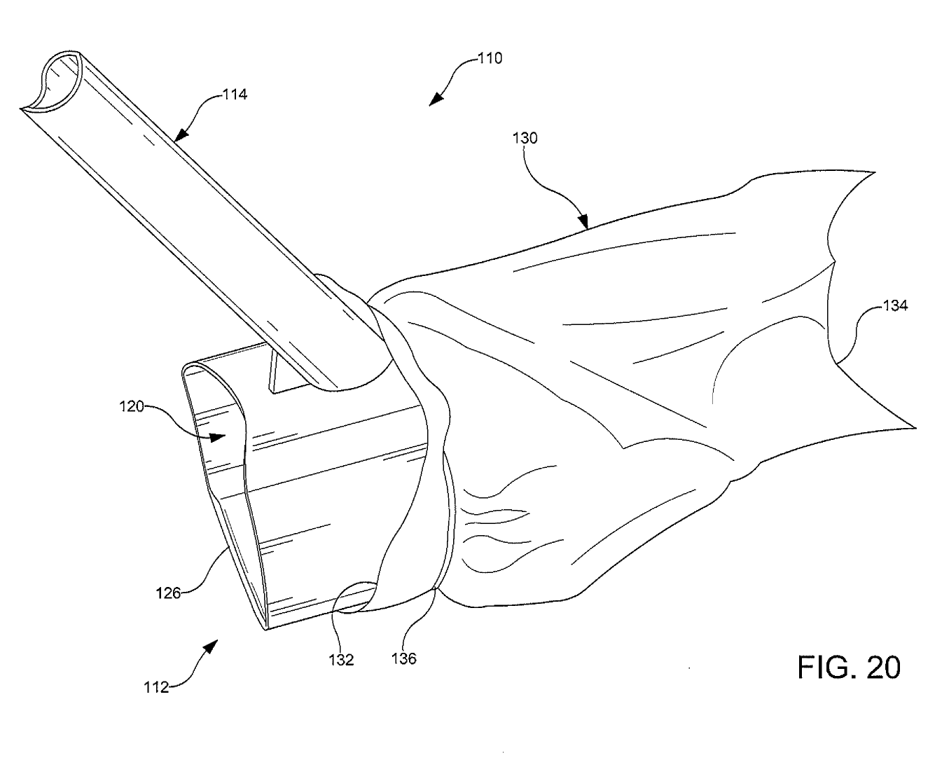

FIGS. 10-20 illustrate a pet mess tool 110 according to an embodiment of the present invention. As shown, the tool 110 has a tube shaped body 112 having a generally oval shaped cross-section. A handle 114 extends generally rearwardly from a portion of the body 112. As a non-limiting example, the handle 114 includes a grip portion 116 disposed thereon to provide an ergonomic gripping surface for a human hand. As a further non-limiting example, the handle 114 is mounted to the body 112 at an angle of approximately forty-five degrees. However, it is understood that the handle 114 can be at any angle relative to the body 112, a desired. Further, the handle 114 can of telescoping construction to adjust to the user and for storage.

The body 112 includes a wall 118 defining a passage 120 through a portion of the body 112. A pair of spaced apart openings 122, 124 is formed in the body 112 to provide access to the passage 120, while the wall 118 encloses a remaining portion of the passage 120. A bottom portion 125 of the wall 118 extends in a generally horizontal plane and terminates at a rear edge 126 disposed adjacent the opening 122. As shown, the bottom portion 125 of the wall 118 is tapered toward the rear edge 126 to assist in separating a “mess” from a surface. However, it is understood that the rear edge 126 may have any shape or bevel, as desired.

A lip 128 or ridge is formed around at least a portion of a periphery of the wall 118 adjacent the opening 124. It is understood that the lip 128 may have any size and shape and may be disposed at any distance from the opening 124. It is further understood that in certain embodiments, the lip 128 is formed adjacent the opening 122.

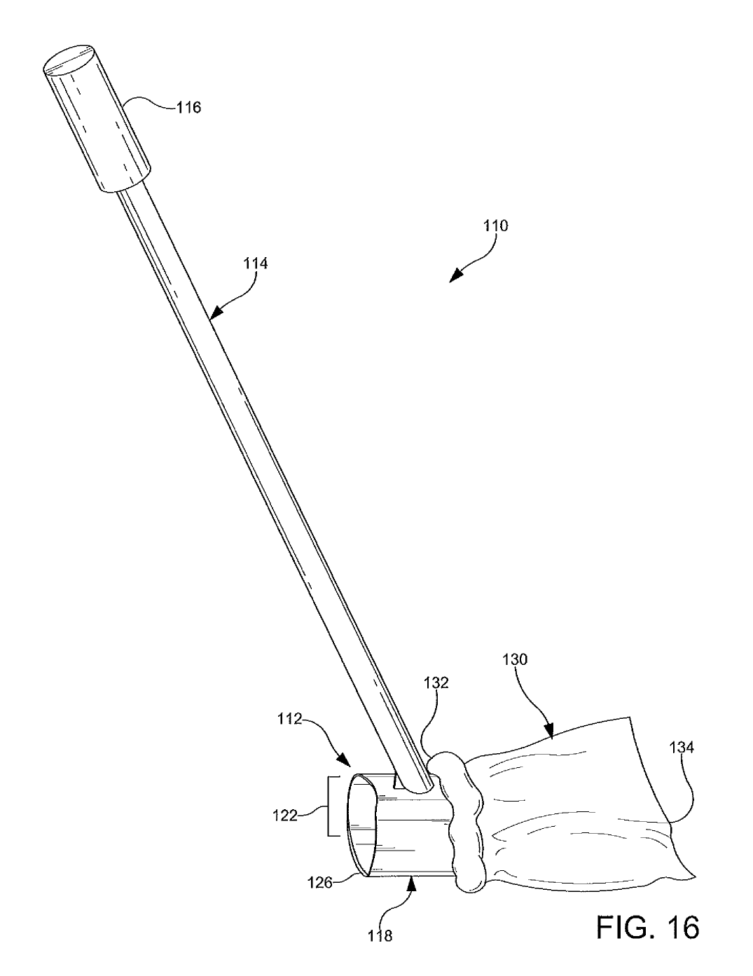

As more clearly shown in FIGS. 16-20 a bag 130 having an open end 132 and a closed end 134 is disposed around a periphery of the wall 118 to enclose the opening 124. As a non-limiting example, the bag 130 is formed from a disposable and pliable material such as plastic, for example. However, the bag 130 can be formed from any material having any size and material properties, as desired.

In certain embodiments, the open end 132 of the bag 130 is disposed around a periphery of the wall 118 such that the lip 128 is enclosed by the bag 130. As such, an elastic band 136 is disposed around a periphery of the bag 130 and adjacent the lip 128 to secure the bag 130 to the wall 118. It is understood that the lip 128 provides a barrier to militate against the bag 130 and the elastic band 136 from slipping off of the wall 118 and exposing the opening 124. It is further understood that any fastening means can be used to secure the bag 130 to the wall 118. As a non-limiting example, the bag 130 may include an integrated elastic band (not shown) or draw sting (not shown) to reduce a circumference of the open end 132 of the bag 130 and secure the bag 130 to the wall 118.

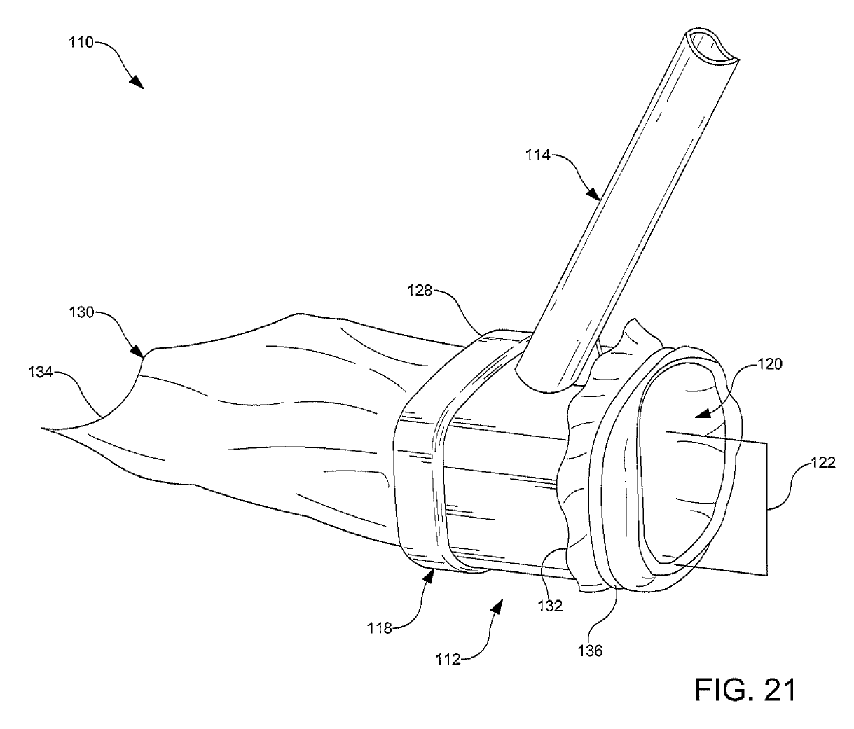

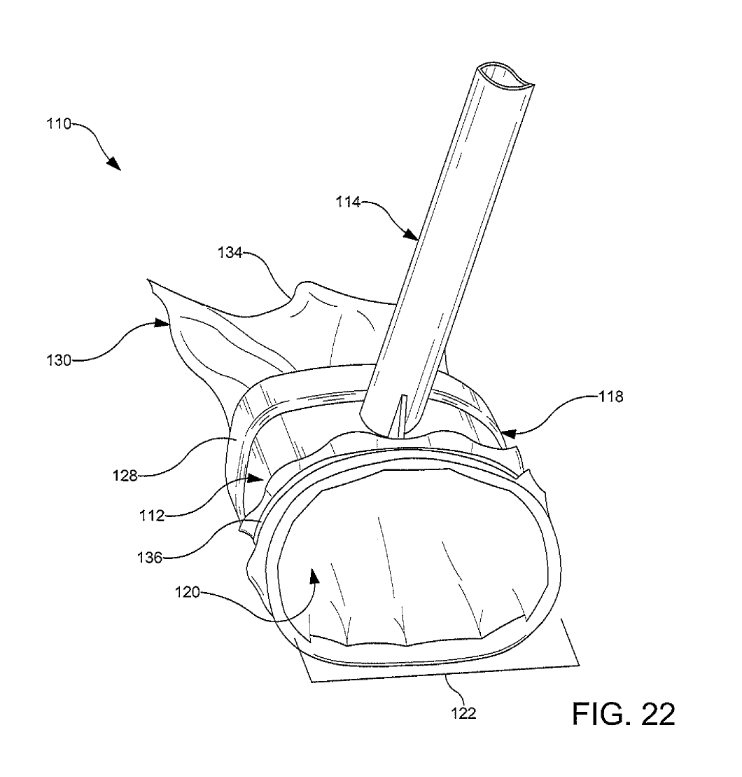

In the embodiment shown in FIGS. 21-22, the open end 132 of the bag 130 is disposed through the opening 124 and the passage 120 such that at least a portion of the bag 130 is adjacent an interior surface of the wall 118 defining the passage 120. The open end 132 of the bag 130 extends from the passage 120 through the opening 122 and is folded such that a portion of the bag 130 encloses a periphery of the wall 118 adjacent the opening 120. As a non-limiting example, a lip (not shown), similar to the lip 128, is disposed adjacent the opening 122 and is enclosed by a folded portion of the bag 130. The elastic band 136 is disposed around a periphery of the bag 130 and adjacent the lip to secure the bag 130 to the wall 118. It is understood that the lip provides a barrier to militate against the bag 130 and the elastic band 136 from slipping off of the wall 118 and exposing the opening 122. It is further understood that the bag 130 provides a protective cover over the interior surface of the wall 118 defining the passage 120. As such, any pet “mess” that is collected by the tool 110 contacts only a portion of the bag 130 and not a surface of the body 112. The cleanliness of the body 112 is maximized since the bag 130 can be removed and disposed of without the pet “mess” directly contacting any surface of the body 112.

In use, a pet “mess” is resting on a surface such as a floor, a rug, a furniture seat cushion, a grassy yard, etc. The tool 110 is positioned with the bottom portion 125 of the wall 118 resting on the surface and the rear edge 126 adjacent the “mess”. Using the handle 114, the tool 110 is rapidly pulled toward the “mess” to engage the “mess”. Since a body at rest tends to stay at rest, the “mess” tends to stay in place as the rear edge 126 is pulled between the “mess” and the surface to scoop the “mess” into the passage 120. In certain embodiments, the “mess” moves through the passage 120 and into the bag 130 for later disposal.

The tool 10, 10′, 10″, 110 provides a means for the pet “mess” 29, 29′, 29″ to be picked up in place, easily transported, and disposed in an appropriate location, while minimizing a residue of the pet “mess” 29, 29′, 29″ on the surface 30, 30′, 30″.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A tool for cleaning a pet mess from a surface, the tool comprising:
a tube shaped body having a wall defining a passage through the body;
a handle extending generally from the body; and
an opening formed in the body in communication with the passage, the opening exposing an edge of a bottom portion of the wall, whereby when the bottom portion of the wall is placed on the surface with the edge adjacent a side of the pet mess and the handle is used to pull the body along a path extending through the pet mess to an opposite side of the pet mess, the pet mess is scooped into the passage.

2. The tool according to claim 1 including a flexible container releasably attached to the body for collecting the pet mess in the container.

3. The tool according to claim 2 wherein the container is a bag.

4. The tool according to claim 2 including a band releasably retaining the container on the body.

5. The tool according to claim 4 wherein the band is an elastic band.

6. The tool according to claim 4 wherein the band is a drawstring.

7. The tool according to claim 4 wherein the band is formed integral with the container.

8. The tool according to claim 2 wherein the body has a lip formed about the opening cooperating with the container to releasably retain the container positioned in the passage.

9. The tool according to claim 2 wherein the body includes another opening in communication with the passage and wherein the body has a lip formed about the another opening cooperating with the container to releasably retain the container extending from the body.

10. The tool according to claim 1 wherein the passage has a generally oval cross-section extending between the opening and another opening formed in the body.

11. The tool according to claim 1 wherein the handle is telescopic.

12. The tool according to claim 1 wherein the handle extends at an acute angle relative to a plane of the bottom portion of the wall.

13. A tool for cleaning a pet mess from a surface, the tool comprising:
a body having a wall defining a passage through the body and having a bottom portion;
a handle coupled to the body and extending therefrom;
a pair of spaced apart openings formed in the body at opposite ends of the passage, wherein an edge of the bottom portion of the wall is exposed at a one of the openings; and
a bag releasably attached to the body, whereby when the bottom portion of the wall is placed on the surface with the edge adjacent one side of the pet mess and the handle is used to pull the body toward an opposite side of the pet mess along a path extending through the pet mess, the pet mess is scooped into the one opening and collected in the bag.

14. The tool according to claim 13 including a band releasably retaining the bag on the body.

15. The tool according to claim 13 wherein the bag extends from the one opening and away from the body.

16. The tool according to claim 13 wherein the bag extends from the one opening into the passage.

17. The tool according to claim 13 wherein the body has a lip formed about the one opening cooperating with the bag to releasably retain the bag.

18. The tool according to claim 13 wherein the passage has a generally oval cross-section extending between the openings.

19. The tool according to claim 13 wherein the handle is telescopic.

20. The tool according to claim 13 wherein the handle extends at an acute angle relative to a plane of the bottom portion of the wall.
